(19) United States
(12) Patent Application Publication
(10) Pub. No.: US 2026/0277499 A1
(43) Pub. Date: Sep. 17, 2026

(54) PRINT PREVIEW INK ESTIMATION MECHANISM

(71) Applicants: Walter F. Kailey, Boulder, CO (US); David Ward, Boulder, CO (US)

(72) Inventors: Walter F. Kailey, Boulder, CO (US); David Ward, Boulder, CO (US)

(73) Assignee: Ricoh Company, Ltd., Tokyo (JP)

(21) Appl. No.: 19/078,069

(22) Filed: Mar. 12, 2025

(51) Int. Cl. G06F 3/12; G06K 15/00

(52) U.S. Cl. CPC G06F 3/1208; G06F 3/1256; G06F 3/1282; G06K 15/407

(57) ABSTRACT

A printing system is disclosed. The printing system includes at least one physical memory device to store print evaluation logic and one or more processors coupled with the at least one physical memory device to execute the print evaluation logic to receive an input image file, process the input image file to generate a first contone image, generate ink usage estimation data based on the first contone image, identify the first contone image as the display image and initiate print preview display of the display image.

### FIELD OF THE INVENTION

The invention relates to the field of image reproduction, and in particular, to performing ink usage estimation for a printing system.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and two tandem print engines for duplex printing that include one or more printhead assemblies, where each assembly includes a printhead controller and a printhead (or array of printheads). Each printhead includes many nozzles (e.g., inkjet nozzles) for the ejection of ink or any colorant suitable for printing on a medium.

### SUMMARY

In one embodiment, a system is disclosed. The system includes at least one physical memory device to store print evaluation logic and one or more processors coupled with the at least one physical memory device to execute the print evaluation logic to receive an input image file, process the input image file to generate a first contone image, generate ink usage estimation data based on the first contone image, identify the first contone image as the display image and initiate print preview display of the display image.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2A-2C are block diagrams of embodiments of a print controller;

FIG. 3 illustrates one embodiment of print evaluation logic;

FIG. 4 illustrates one embodiment of preview generation logic;

FIG. 5 illustrates one embodiment of an image processing engine;

FIG. 6 is a flow diagram illustrating one embodiment of a process for generating a preview image;

FIG. 7 illustrates one embodiment of ink estimation logic;

FIG. 8 is a flow diagram illustrating one embodiment of an ink estimation process;

FIG. 9 is a flow diagram illustrating one embodiment of a dual use job preview ink estimation process; and

FIG. 10 illustrates one embodiment of a computer system.

### DETAILED DESCRIPTION

In commercial and transactional printers, it is common to estimate ink usage prior to printing a print job to determine one of the major components of the cost to print a job. Conventional ink estimation (e.g., ink usage estimation) methods are implemented using a printer-resolution (e.g., 600 dpi or 1200 dpi) contone bit map (e.g., a raster image produced by a raster image processor or RIP) of an input print image followed by one of two general ink estimation processes. The first process involves halftoning the contone image, counting drops for each drop size, multiplying the drop count by drop size, and performing a sum over drop sizes to yield an estimated ink usage amount. The second process comprises applying a gray level histogram. One embodiment of the histogram ink estimation method comprises computing a gray level histogram of the raster image, multiplying histogram values by probabilities for each drop size and summing over drop sizes to yield an estimated ink usage amount. Both of these ink estimation processes are performed separately for each color of ink. Once ink usage is estimated for each color, a sum over certain colors (e.g., CMY) may be performed. The above processes maximize theoretical accuracy of ink estimates, while providing a printer resolution contone image that is unrealistic (e.g., too sharp and does not show physical printing characteristics such as dot gain where printed ink dots on paper show blurring due to ink-on-paper diffusion or paper motion) for use as a print preview. Moreover, performing the ink estimation with a printer resolution contone image is burdensome and comparable in computational cost to actually printing the job.

A lower-resolution (e.g., 72 dpi) contone image used for print preview function may be performed on demand when a print preview is requested. Yet, such low-resolution contone image typically cannot be used for ink estimation since the low resolution does not support the accuracy needed for ink estimation processes. Moreover, scaling the print preview to higher resolution to support a magnified view requires a newly generated contone image at a higher resolution.

According to one embodiment, a mechanism is provided to generate a scalable print preview contone image that supports accurate in ink estimation in a single pass. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

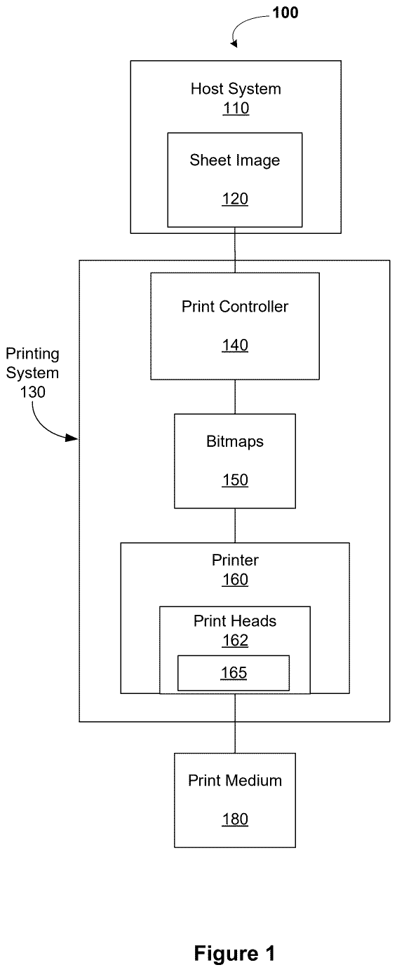

FIG. 1 is a block diagram illustrating one embodiment of a printing system 130. A host system 110 is in communication with the printing system 130 to print a sheet image 120 onto a print medium 180 via a printer 160 (e.g., one or more print engines). Print medium 180 may include paper, card stock, paper board, corrugated fiberboard, film, plastic, synthetic, textile, glass, composite or any other tangible medium suitable for printing. The format of print medium 180 may be continuous form or cut sheet or any other format suitable for printing. Printer 160 may be an ink jet or another suitable printer type.

In one embodiment, printer 160 comprises one or more printheads 162, each including one or more pel forming elements 165 that directly or indirectly (e.g., by transfer of marking material through an intermediary) forms the representation of picture elements (pels) on the print medium 180 with marking material applied to the print medium. In an ink jet printer, the pel forming element 165 (e.g., an ink jet nozzle) is a tangible device that ejects the ink (e.g., ink drops) onto the print medium 180. Typically, an ink jet nozzle ejects ink based on an actuator energized by an applied waveform. The waveforms for printing print data versus flushing (e.g., printing flush lines) are typically different due to optimizations for those different functions. The pel forming elements may be grouped onto one or more printheads 162.

The pel forming elements 165 may be stationary (e.g., as part of a stationary printhead 162) or moving (e.g., as part of a printhead 162 that moves across the print medium 180) as a matter of design choice. Further, the pel forming elements 165 may be assigned to one of one or more color planes that correspond to types of marking materials (e.g., Cyan, Magenta, Yellow, and black (CMYK)). Marking materials may be inks, paints, resins or other materials suitable for printing. The set of marking materials installed in the printer are also known as process colors.

In a further embodiment, printer 160 is a multi-pass printer (e.g., dual pass, 3 pass, 4 pass, etc.) wherein multiple sets of pel forming elements 165 print the same region of the print image on the print medium 180. The set of pel forming elements 165 may be located on the same physical structure (e.g., an array of nozzles on an ink jet print head 162) or separate physical structures. The resulting print medium 180 may be printed in color and/or in any of a number of gray shades, including black and white (e.g., Cyan, Magenta, Yellow, and black, (CMYK)). The host system 110 may include any computing device, such as a personal computer, a server, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, PDF and/or any other printer language data. The printer controller 140 processes the sheet image to generate a bitmap 150 for transmission. The bitmap 150 includes the instructions (e.g., instructed ink drop size and/or instructed pel forming element location) for the one or more printheads 162 and pel forming elements 165. Bitmap 150 may be a halftoned bitmap for printing to the print medium 180. The printing system 130 may be a high-speed printer operable to print relatively high volumes (e.g., greater than 100 pages per minute).

The print medium 180 may be continuous form paper, cut sheet paper, and/or any other tangible medium suitable for printing. The printing system 130, in one generalized form, includes the printer 160 that presents the bitmap 150 onto the print medium 180 (e.g., via toner, ink, etc.) based on the sheet image 120. Although shown as a component of printing system 130, other embodiments may feature printer 160 as an independent device communicably coupled to printer controller 140.

The printer controller 140 may be any system, device, software, circuitry and/or other suitable component operable to transform the sheet image 120 for generating the bitmap 150 in accordance with printing onto the print medium 180. In this regard, the printer controller 140 may include processing and data storage capabilities.

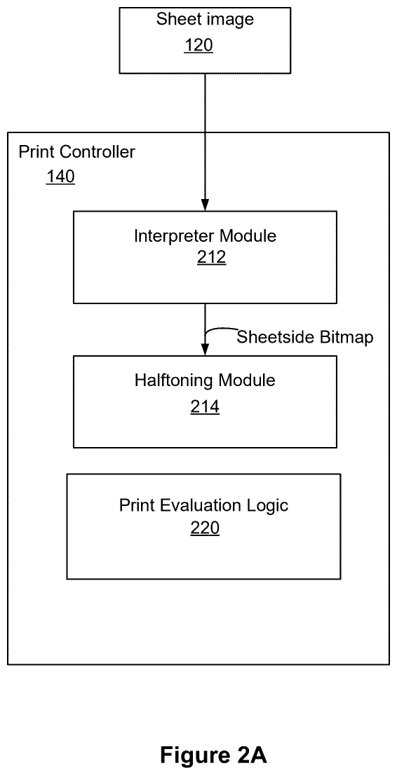

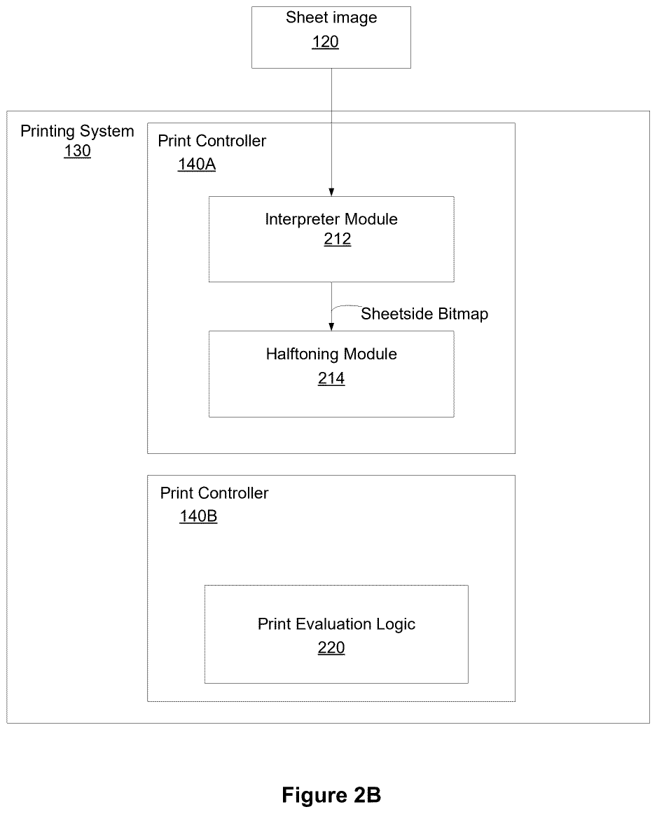

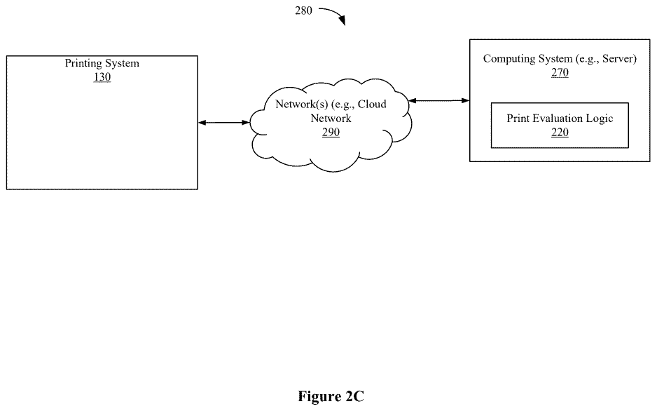

FIGS. 2A&2B are block diagrams illustrating embodiments of a printer controller 140. As shown in FIG. 2A, printer controller 140 (e.g., DFE or digital front end), in its generalized form, includes interpreter module 212, halftoning module 214 and print evaluation logic 220. These separate components may represent hardware used to implement the printer controller 140. Alternatively, or additionally, the separate components may represent logical blocks implemented by executing software instructions in a processor of the printer controller 140.

FIG. 2B illustrates an alternative embodiment having print controllers 140A&140B. In this embodiment, printer controller 140A includes interpreter module 212 and halftoning module 214, while printer controller 140B includes print evaluation logic 220. Print controllers 140A and 140B may be implemented in the same printing system 130 (as shown) or may be implemented separately.

Although shown as a component inside of print controller 140, other embodiments may feature print evaluation logic 220 included within independent devices communicably coupled to print controller 140. For instance, FIG. 2C illustrates one embodiment of print evaluation logic 220 implemented in a network 280. As shown in FIG. 2C, print evaluation logic 220 is included in a computing system 270. In one embodiment, data may be transferred between print evaluation logic 220 and printing system 130 via a cloud network 290.

Interpreter module 212 is operable to interpret, render, rasterize, or otherwise convert print instructions (e.g., raw sheetside images such as one or more sheet image 120) of a print job into sheetside bitmaps targeted for each print engine of printer 160. The sheetside bitmaps generated by interpreter module 212 are each a 2-dimensional array of pixels representing an image of the print job (e.g., a contone image or Continuous Tone Image (CTI)), also referred to as full sheetside bitmaps. The 2-dimensional pixel arrays are considered “full” sheetside bitmaps because the bitmaps include the set of pixels for the image. In one embodiment, interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel gray levels to output drop sizes based on pixel location. While halftoning module 214 is shown as a part of print controller 140, halftoning module 214 may be implemented separately such as a part of printer 160. In that case, instead of print controller 140 transmitting halftone bitmaps to printer 160, contone image bitmaps are transmitted to printer 160.

Print evaluation logic 220 receives print job sheet images and processes the images to generate contone images sufficient for both print preview and ink estimation. According to one embodiment, print evaluation logic receives an input image file, processes the input image file to generate a first contone image, generates ink usage estimation data based on the first contone image, identifies the first contone image as the display image and initiates print preview display of the display image. Resulting technical benefits include generating ink usage estimation and initiating a print preview display.

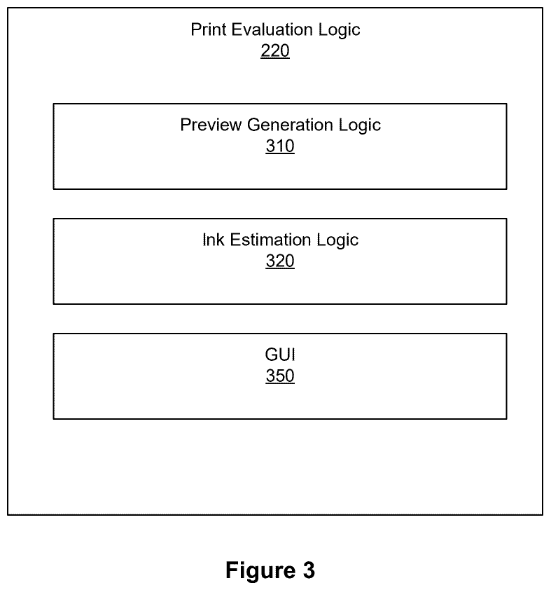

FIG. 3 illustrates one embodiment of print evaluation logic 220 including preview generation logic 310, ink estimation logic 320 and graphical user interface (GUI) 350. Preview generation logic 310 generates contone images for print preview (or preview images) at GUI 350. In one embodiment, preview generation logic 310 generates preview images in response to a print preview request received from a user via GUI 350. Resulting technical benefits include receiving print preview requests from users that may be acted upon to produce desired preview images.

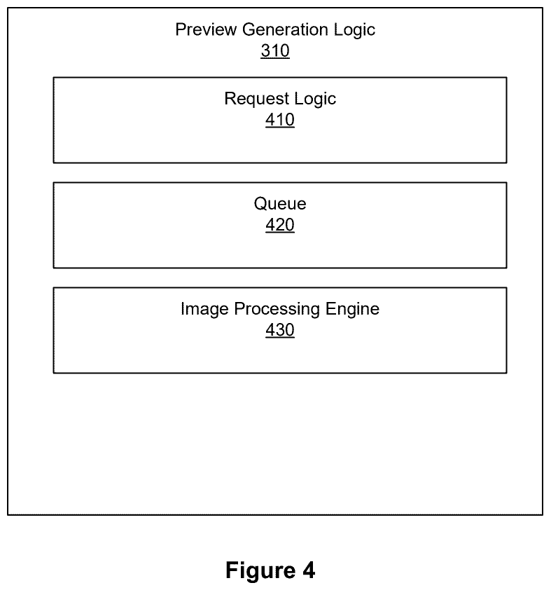

FIG. 4 illustrates one embodiment of preview generation logic 310. As shown in FIG. 4, preview generation logic 310 includes request logic 410, queue 420 and image processing engine 430. Request logic 410 receives requests from GUI 350 to preview an image in a received print job. In one embodiment, print job contone images are stored in queue 420. In such an embodiment, a user request to preview an image of a print job image results in the associated contone image being moved to the top of queue 420.

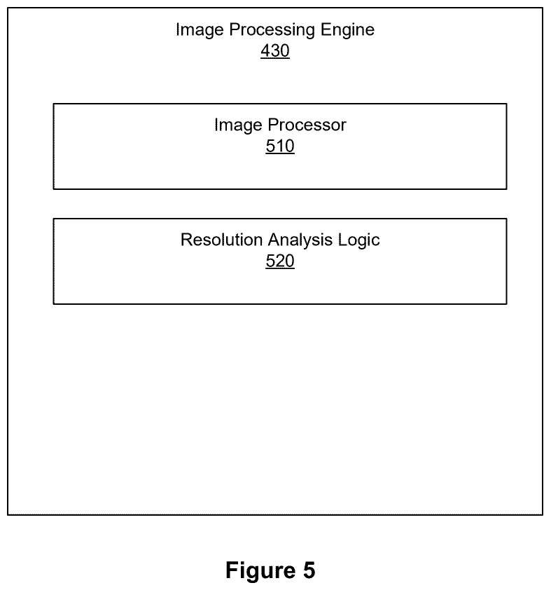

Image processing engine 430 performs image processing (similar to the function described above for interpreter module 212) on received print job images to generate the contone images, which are subsequently stored in queue 420. FIG. 5 illustrates one embodiment of image processing engine 430 including image processor 510 and resolution analysis logic 520. Image processor 510 processes received print job images to generate corresponding contone images. In one embodiment, image processor 510 performs a rasterization on each received print job image to convert the print job images to contone images (first contone images) that can be displayed on a display device (e.g., devices to present images electronically as visual pixels). As used herein, references to image or images may refer to one of more images. In such an embodiment, the contone images comprise contone bitmap images.

Image processing engine 430 receives a print preview request, generates second contone images based on the first contone images and identify the second contone image as the display image, where the first contone images have a first resolution (e.g., within a range of 150 to 450 dpi) and the second contone images have a second resolution. The first resolution may be different (e.g., less than or greater than) than the second resolution. In one embodiment, resolution analysis logic 520 receives a print job preview request and determines additional processing that is to be formed on a contone image for print previewing. Print preview scaling involves adjusting the size of the content displayed in the print preview display. The resolution of the display used for print preview is set at a fixed value determined by the display hardware design in use. This process can include scaling to change the overall size of the image content to better fit the display dimensions or to improve readability. The scaling can involve increasing or decreasing the corresponding apparent physical size of printed matter displayed in print preview image elements. Resulting technical benefits include providing an updated print preview based on the print preview request.

As used herein, enlargement is increasing the corresponding apparent physical size of displayed print preview image elements, and reduction is decreasing the corresponding physical size of displayed print preview elements. In other words, one may consider the ratio of resolution of the image to be displayed to the fixed resolution of the display. If the print preview image resolution is greater than the display resolution, one will get an enlarged (magnified) apparent size of displayed objects and a smaller field of view. If the print preview image resolution is less than the display resolution, one will get a reduced apparent size of displayed objects and a larger field of view. In one embodiment, a print job preview request may indicate a request resolution which is the image resolution at which to render the print preview contone image for display. In such an embodiment, resolution analysis logic 520 receives a resolution request value and determines whether the resolution request value is higher (or greater) than the resolution of the first contone image. The print preview request may indicate the resolution request value directly (e.g., 100 dpi) or may indicate it indirectly (e.g., a change to the current print preview resolution factor such as ½×, ⅔×, 1.5×, 2×, etc.) The resolution factor is defined as the number of printer output resolution pixels (or dots) per preview display pixel. This may be a fractional or whole number and is typically greater than or equal to 1.

Image processing engine 430 determines the indicated resolution request value based on the print preview request. The print preview resolution request may be obtained via GUI 350, which allows the user to select any job in the queue by clicking on an icon for that job. Selecting (or clicking on) the job icon results in one or more sheet side images being displayed in the GUI. The user may click on a page to see it at different resolutions (sizes). The user may click on “zoom buttons” nearby to make the sheet being previewed appear larger or smaller on the screen. The zoom buttons may increase or decrease the size of the preview by factors, such as ½, ⅔, 1.5, 2, etc. When the zoom buttons are pressed for the selected sheet within the selected job, the corresponding print preview request is sent. The print preview request includes the job number, sheet number, and requested resolution factor.

According to one embodiment, image processor 510 generates updated (or display) contone images (e.g., second contone image) with an image reduction operation upon a determination at resolution analysis logic 520 that the resolution request value is lower (or less) than the resolution of the first contone image. In one embodiment, image processor 510 performs an area scaling operation to modify the first contone image to a display resolution (e.g., decreases the resolution of the contone image). Area scaling comprises a process of changing the size of a specific region within an image by manipulating pixel dimensions of the region while maintaining the overall image structure. Thus, the area scaling accurately simulates printing viewed at low resolution.

Area scaling involves mapping printed pixels at printer resolution onto preview display pixels at preview display resolution. For each preview display pixel, the average color is computed using a weighted average of printer pixels contained completely or partially within the preview display pixel. Each printer resolution printer is weighted by the portion of its area contained within the preview display pixel. A weighted average is the sum of the weights multiplied by the color values (typically 8-bit values for each color of ink), divided by the sum of the weights.

Image processor 510 performs an image enlargement operation to modify the display resolution (e.g., increases the resolution of the contone image) in order to generate updated (or display) contone images (e.g., second contone image) upon a determination at resolution analysis logic 520 that the resolution request value is higher (or more) than the resolution value of the contone image. In one embodiment, the image enlargement operation comprises a bicubic interpolation operation that calculates new pixel values by considering a 4×4 neighborhood of surrounding pixels, utilizing cubic polynomials to create smoother transitions and preserving fine details when resizing or scaling an image. Thus, bicubic interpolation accurately simulates printing viewed at higher resolutions than the preview contone image (e.g., the first contone image), because the preview contone image resolution is at or above the resolution of the human retina when viewing the printed medium containing diffused ink drops. This resolution was chosen beforehand based on the printer resolution, print medium dot gain, and human eye resolution. It is typically from 150 to 450 dpi, depending on the dot gain of the printed medium. The preview contone image resolution is predetermined and much less than the printer resolution of 600 to 1200 dpi. The technical advantage of choosing the preview resolution in this way is that accurate previews are obtained at much lower computational cost than that of actually printing the image.

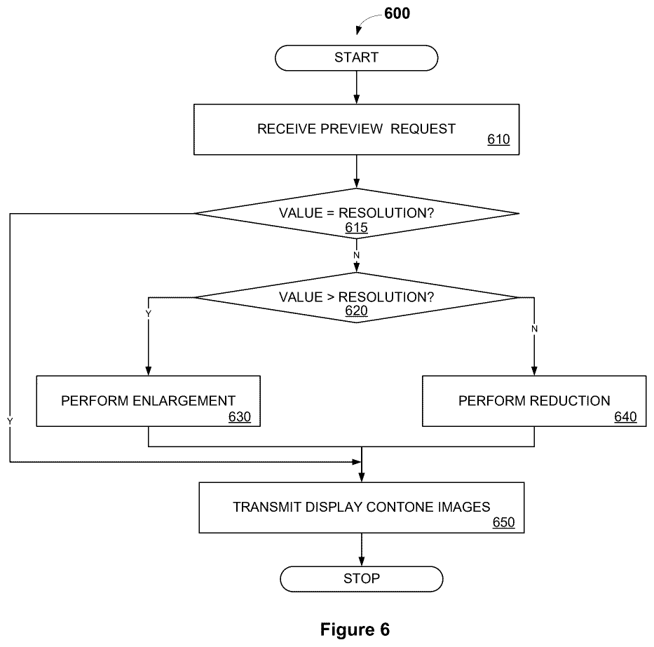

FIG. 6 is a flow diagram illustrating a process 600 for generating a print preview image. Process 600 may be performed by processing logic that may include hardware (e.g., circuitry, dedicated logic, programmable logic, microcode, etc.), software such as instructions run on a processing device, or a combination thereof. In one embodiment, process 600 is performed by image processing engine 430. For brevity, clarity, and ease of understanding, many of the details discussed with reference to FIGS. 1-5 are not discussed or repeated here.

Process 600 begins at processing blocks 610, where a print preview request is received. At decision block 615, a determination is made as to whether the resolution request value included in the print preview request equals the contone image resolution (e.g., 300 dots per inch (dpi)). The resolution request value may be obtained from the display resolution factor and the contone resolution by multiplying the contone resolution by the display resolution factor. If the resolution request value equals the contone image resolution value, the contone images are the display contone images and are transmitted at processing block 650 (e.g., for storage and/or to initiate print preview display). Resulting technical benefits include avoiding unnecessary computational burdens to match preview requests. Otherwise, a determination is made, at decision block 620, as to whether the resolution request value included in the print preview request is greater than the contone image resolution.

Display contone images are generated by performing an image enlargement (e.g., bicubic interpolation operation) on the contone images upon a determination that the resolution request value included in the print preview request is greater than the contone image resolution, processing block 630. Otherwise, the display contone images are generated by performing an image reduction operation (e.g., an area scaling operation) on the contone images, processing block 640. At processing block 650, the display contone images are transmitted (e.g., for storage and/or to initiate print preview display). Resulting technical benefits include providing adjusted display image to match preview requests.

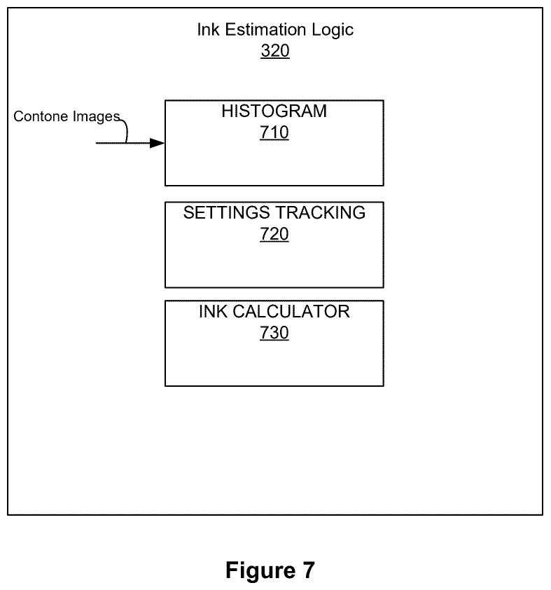

Referring back to FIG. 3, ink estimation logic 320 is implemented to generate ink estimate data that provides an estimation of ink that is to be used to produce a print job. In such an embodiment, ink estimation logic 320 uses gray level histogram data for each color plane (e.g., CMYK) to estimate the print job ink usage. FIG. 7 illustrates one embodiment of ink estimation logic 320, including histogram engine 710, settings tracking module 720 and ink calculator logic 730. One technical benefit for ink estimation based on histograms is that no specific knowledge of the halftone design is needed.

Histogram engine 710 generates a gray level histogram based on the generated contone images for each color plane implemented to print a print job. A histogram is a distribution of a number of pixels for every gray level for each color plane over the total print job. In one embodiment, the histogram is generated without using halftone design data. Resulting technical benefits include providing a gray level histogram for use in ink estimation processes.

In one embodiment, histogram engine 710 receives contone images corresponding to each color plane of a print job that is to be printed and generates a histogram for each color plane by counting the digital count value for each pel over a total range of allowable digital count values. For a CMYK contone image, the total number of gray levels per color plane=2ⁿ, where n=bit depth. Accordingly, four histograms are generated to define all possible colors for a print job in the CMYK (e.g., for process colors) color space.

In other embodiments, more colorants may be used (e.g., Magnetic Ink Character Recognition (MICR), Protector, etc.) and those planes may be processed/estimated likewise. In a further embodiment, histograms may show the distribution with bucket sizes having multiple gray levels in each bucket to increase performance with a small decrease in accuracy.

Settings tracking module 720 acquires and stores print job settings and printer system settings that are used in conjunction with the histograms to perform ink estimation. In one embodiment, the print job settings and printer system settings are received via GUI 350. However other embodiments may comprise settings tracking module 720 receiving the print job settings information via a job ticket submitted with the print job and/or components of print controller 140.

In one embodiment, print job settings include information, such as print scaling, n-up or other imposition, print quality, print output resolution, number copies, simplex/duplex. In a further embodiment, one or more of these print job settings may be included in a print job settings group (e.g., a job ticket). Moreover, many of the print job settings may already be accounted for in sheetmaps, such as imposition, resolution and number of copies. Printer system settings may include information for printer 160, such as an ink deposition curve, print resolution, flushing type, post-processing marks, undercoat/overcoat type, ink selection, density mode, print speed or the printer type/model. One or more of the printer system settings may also be included in a printer system settings group (e.g., a printer snapshot or printer profile).

An ink deposition curve or table is an offline measurement of a vector of an amount of ink in a pixel (or per area) deposited for different gray levels; where more ink is provided as the gray level increases and no ink is applied for white. Ink deposition curves may be specific to printer system settings such as print engine type and ink type. Ink deposition curves may also be automatically selected based on the printer system settings.

Ink calculator 730 computes ink estimation data representing an estimated ink usage based on the color histogram, print job settings and/or print system settings. According to one embodiment, ink calculator 730 computes a total volume of ink as a dot product of the histogram and the ink deposition curve on a per pixel and per color plane basis, such that for each color plane:

$$\begin{matrix}{Volume}_{estimate} = {\sum }_{i = 0}^{{2}^{bitDepth} - 1} {Histogram}_{i} \cdot {InkDeposition}_{i} \\ = \vec{Histogram} ∘ \vec{InkDeposition} \\ \end{matrix}$$

In this equation, the InkDeposition value is a volume of ink (e.g., picoliters), which may be obtained from the probability distribution of ink drop sizes associated with each digital value in the histogram. The InkDeposition value for a given digital value is obtained by multiplying the probability of each drop size associated with the digital value by the volume of that drop size and summing over all the drop sizes available.

In another embodiment, ink calculator 730 may adjust ink usage for each color plane based on print job settings. For example, an estimated ink usage for a single copy of a print job may be adjusted to account for multiple copies of the job by multiplying the estimated ink usage of the print job by the number of copies of the print job. Thus, ink calculator 730 computes estimated ink usage for each color plane for a print job.

The volume estimate determines ink that is related to the histogram generated from the contone image data. This may not account for all of the sources of ink usage such as when the printer engine adds flushing patterns or ejects ink for maintenance purposes. To account for additional ink usage that is not accounted for by the histogram, the initial estimated volume is adjusted to obtain a new estimated volume based on printer system settings (e.g., flushing type, post-processing marks, or printhead maintenance type) or print job settings that cause ink usage not accounted for in the histograms. This may take the form of the ink estimation logic 320 calculating additional volumes of ink per linear displacement of the web or per page based on the print job and the corresponding printer system settings or print job settings.

Likewise, ink calculator 730 may estimate other ink usage quantities from a dot product with the histograms. Most notably, page coverage data (the average amount of the page covered by ink) can be estimated from this method. Here, there are various options available, including: 1) a measure of all non-zero pels, or 2) a weighted measure of the pels based on their relative darkness.

In yet a further embodiment, ink estimation logic may also generate ink estimates that include maintenance ink usage. Generating the ink usage estimation data comprises generating maintenance ink usage data based on the first contone image and generating modified ink usage data based on the ink usage estimation data and the maintenance ink usage data. Maintenance ink usage comprises a quantity of ink that will be used to for flushing lines to be printed by pel forming elements 162 and may be based on the printer system settings and/or the print job sheet images. In a further embodiment, the maintenance ink usage is generated separately and added to the above-described ink usage estimate to generate a modified ink usage data. Resulting technical benefits include ink usage estimates that account for maintenance ink usage.

The ink calculator 730 may further adjust the ink estimate to account for a printer output resolution setting value that is different than resolution value of first contone image. In one embodiment, ink calculator 730 may adjust the ink estimate by multiplying the ink estimate by a resolution factor based on resolution used for the ink estimate (e.g., first contone image resolution) setting and the printer output resolution. For example, if the first contone image is down-sampled (e.g., a down sampled image resolution) from the printer output resolution by a factor of two in both directions, this results in the first contone image having one quarter of the pixels of the printer output. An ink estimate based on the down sampled image must then be scaled by a factor of four to obtain an estimate for the ink usage of the original contone image. More generally, an ink estimate scaling factor for resolution may be defined as:

$$IESF = \frac{{PR}_{crossweb} \times {PR}_{transport}}{{CTIR}_{crossweb} \times {CTIR}_{transport}} = {RF}_{crossweb} \times {RF}_{transport}$$

where IESF is the ink estimate scaling factor, PR is the printer resolution in the cross-web or transport direction, CTIR is the contone image resolution in the cross-web or transport direction, and RF is the resolution factor in the cross-web or transport direction. The final ink estimate for any given color plane of any given page is the ink estimate derived from the contone image multiplied by IESF.

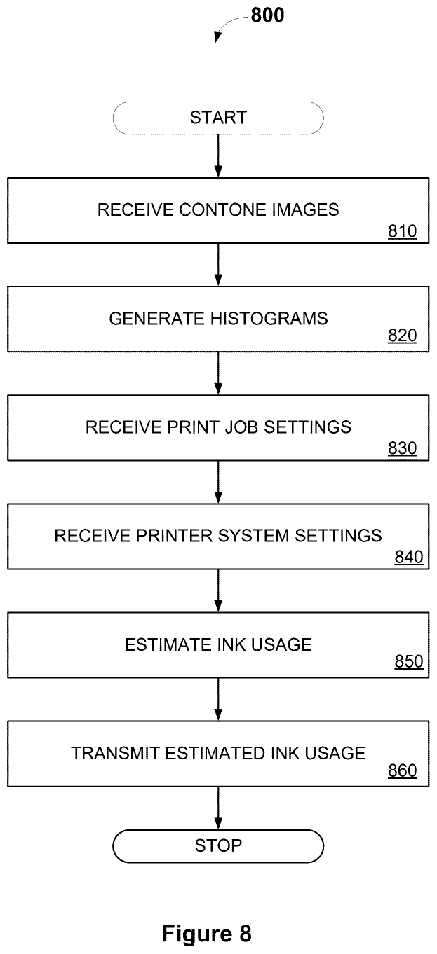

FIG. 8 is a flow diagram illustrating one embodiment of a process 800 for performing ink estimation. Process 800 may be performed by processing logic that may comprise hardware (e.g., circuitry, dedicated logic, programmable logic, etc.), software (such as instructions run on a processing device), or a combination thereof. In one embodiment, process 800 may be performed by ink estimation logic 320. The process 800 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-7 are not discussed or repeated here.

Process 800 begins at processing block 810, where contone images are received. At processing block 820, histograms are generated or received (e.g., received from histogram engine 710, from shared memory, etc.) for each color plane based on the contone images. At processing block 830, print job settings are received. At processing block 840, the printer system settings may be received. As discussed above, the print job settings and printer system settings may be received via GUI 350, from host system 110 or any combination of the GUI 350 and host system 110.

At processing block 850, the estimated volume of ink usage is computed based on the histograms, the printer system settings and/or the print job settings. At processing block 860, the estimated ink usage data is stored or transmitted (e.g., reported). In one embodiment, estimated ink usage is displayed via GUI 350. Resulting technical benefits include making the ink estimate available.

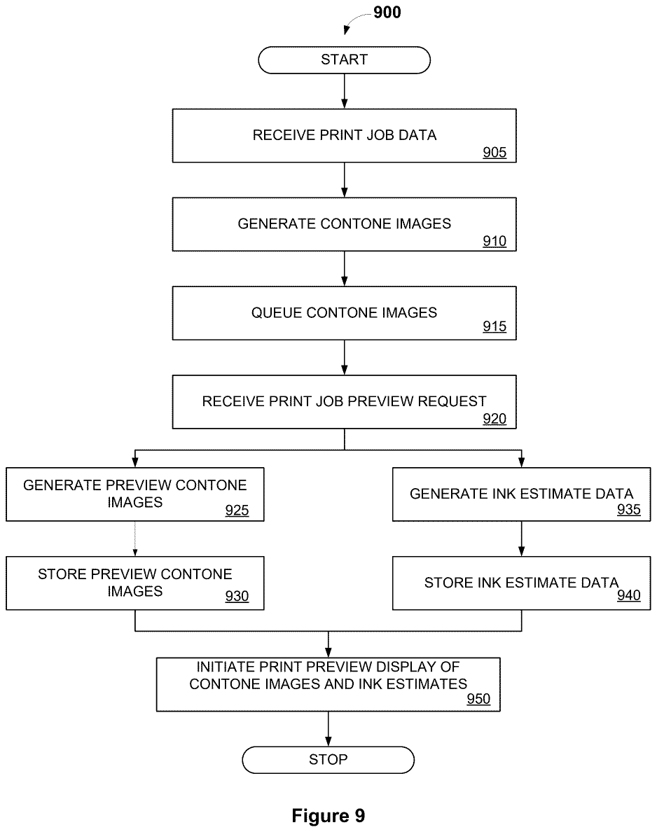

FIG. 9 is a flow diagram illustrating one embodiment of a dual use print job preview and ink estimation process 900. Process 900 may be performed by processing logic that may comprise hardware (e.g., circuitry, dedicated logic, programmable logic, etc.), software (such as instructions run on a processing device), or a combination thereof. In one embodiment, process 900 may be performed by print evaluation logic 220. The process 900 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-8 are not discussed or repeated here.

Process 900 begins at processing block 905, where print job data is received. At processing block 910, contone images are generated. At processing block 915, the print job contone images are stored in the queue. A print job preview request is received some indefinite time after the contone images have been queued, processing block 920. At processing blocks 925 and 930, preview contone images are generated and stored, respectively. In parallel, after each contone image has been generated, the ink estimate data derived from that image is similarly generated, stored, and used within the corresponding ink estimate, at processing blocks 935 and 940, respectively. At processing block 950, a print preview display of the display contone image and/or the ink usage estimate data is initiated.

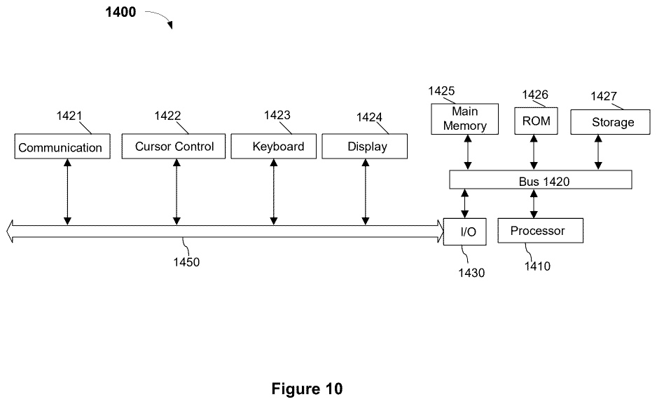

FIG. 10 illustrates a computer system 1400 on which printing system 130, printer controller 140, and/or print evaluation logic 220 may be implemented. Computer system 1400 includes a system bus 1420 for communicating information, and a processor 1410 coupled to bus 1420 for processing information.

Computer system 1400 further comprises a random access memory (RAM) or other dynamic storage device 1425 (referred to herein as main memory), coupled to bus 1420 for storing information and instructions to be executed by processor 1410. Main memory 1425 also may be used for storing temporary variables or other intermediate information during execution of instructions by processor 1410. Computer system 1400 also may include a read only memory (ROM) and/or other static storage device 1426 coupled to bus 1420 for storing static information and instructions used by processor 1410.

A data storage device 1427 such as a magnetic disk or optical disc and its corresponding drive may also be coupled to computer system 1400 for storing information and instructions. Computer system 1400 can also be coupled to a second I/O bus 1450 via an I/O interface 1430. A plurality of I/O devices may be coupled to I/O bus 1450, including a display device 1424, an input device (e.g., an alphanumeric input device 1423 and or a cursor control device 1422). The communication device 1421 is for accessing other computers (servers or clients). The communication device 1421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes at least one physical memory device to store print evaluation logic and one or more processors coupled with the at least one physical memory device to execute the print evaluation logic to receive an input image file, process the input image file to generate a first contone image, generate ink usage estimation data based on the first contone image, identify the first contone image as the display image and initiate print preview display of the display image.

Example 2 includes the subject matter of Example 1, wherein the print evaluation logic further to transmit the ink usage estimation data.

Example 3 includes the subject matter of Examples 1 and 2, wherein generating the ink usage estimation data comprises generating maintenance ink usage data based on the first contone image and generating modified ink usage data based on the ink usage estimation data and the maintenance ink usage data.

Example 4 includes the subject matter of Examples 1-3, wherein print control logic further to receive a print preview request and generate a second contone image based on the first contone image and identify the second contone image as the display image.

Example 5 includes the subject matter of Examples 1-4, wherein the first contone image comprises a first image resolution value and the second contone image comprises a second image resolution value, the first image resolution value different than the second image resolution value.

Example 6 includes the subject matter of Examples 1-5, wherein generating the second contone image comprises determining whether the print preview request indicates a request resolution value greater than the first resolution value and modifying the first contone image by applying an image reduction operation upon determining that the print preview request indicates the request resolution value not greater than the first resolution value.

Example 7 includes the subject matter of Examples 1-6, wherein generating the second contone image comprises modifying the first contone image by applying an image enlargement operation upon determining that the print preview request indicates the request resolution value greater than the first resolution value.

Example 8 includes the subject matter of Examples 1-7, further comprising determining whether the print preview request indicates the request resolution value equal to the first resolution value and identifying the first contone image as the display image upon determining the print preview request indicates the request resolution value equal to the first resolution value.

Example 9 includes the subject matter of Examples 1-8, wherein generating the ink usage estimation data comprises generating a gray level histogram data based on the first contone image.

Example 10 includes the subject matter of Examples 1-9, wherein the memory device to further store a graphical user interface (GUI) and the one or more processors to execute the GUI to receive the print preview request.

Example 11 includes the subject matter of Examples 1-10, further comprising a printer.

Some embodiments pertain to Example 12 that includes at least one computer readable medium having instructions stored thereon, which when executed by one or more processors, cause the processors to receive an input image file, process the input image file to generate a first contone image, generate ink usage estimation data based on the first contone image, identify the first contone image as the display image and initiate print preview display of the display image.

Example 13 includes the subject matter of Example 12, wherein generating the ink usage estimation data comprises generating maintenance ink usage data based on the first contone image and generating modified ink usage data based on the ink usage estimation data and the maintenance ink usage data.

Example 14 includes the subject matter of Examples 12 and 13, having instructions stored thereon, which when executed by one or more processors, further cause the processors to receive a print preview request and generate a second contone image based on the first contone image and identify the second contone image as the display image.

Example 15 includes the subject matter of Examples 12-14, wherein the first contone image comprises a first image resolution value and the second contone image comprises a second image resolution value, the first image resolution value different than the second image resolution value.

Example 16 includes the subject matter of Examples 12-15, wherein generating the second contone image comprises determining whether the print preview request indicates a request resolution value greater than the first resolution value and modifying the first contone image by applying an image reduction operation upon determining that the print preview request indicates the request resolution value not greater than the first resolution value.

Some embodiments pertain to Example 17 that includes a method comprising receiving an input image file, processing the input image file to generate a first contone image, generating ink usage estimation data based on the first contone image, identifying the first contone image as the display image and initiating print preview display of the display image.

Example 18 includes the subject matter of Example 17, further comprising wherein generating the ink usage estimation data comprises generating maintenance ink usage data based on the first contone image and generating modified ink usage data based on the ink usage estimation data and the maintenance ink usage data.

Example 19 includes the subject matter of Examples 17 and 18, further comprising receiving a print preview request and generating a second contone image based on the first contone image and identify the second contone image as the display image.

Example 20 includes the subject matter of Examples 17-19, wherein the first contone image comprises a first image resolution value and the second contone image comprises a second image resolution value, the first image resolution value different than the second image resolution value.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
at least one physical memory device to store print evaluation logic; and
one or more processors coupled with the at least one physical memory device to execute the print evaluation logic to:
receive an input image file;
process the input image file to generate a first contone image;
generate ink usage estimation data based on the first contone image;
identify the first contone image as the display image; and
initiate print preview display of the display image.

2. The system of claim 1, wherein the print evaluation logic further to transmit the ink usage estimation data.

3. The system of claim 1, wherein generating the ink usage estimation data comprises generating maintenance ink usage data based on the first contone image and generating modified ink usage data based on the ink usage estimation data and the maintenance ink usage data.

4. The system of claim 1, wherein print control logic further to receive a print preview request and generate a second contone image based on the first contone image and identify the second contone image as the display image.

5. The system of claim 4, wherein the first contone image comprises a first image resolution value and the second contone image comprises a second image resolution value, the first image resolution value different than the second image resolution value.

6. The system of claim 5, wherein generating the second contone image comprises determining whether the print preview request indicates a request resolution value greater than the first resolution value and modifying the first contone image by applying an image reduction operation upon determining that the print preview request indicates the request resolution value not greater than the first resolution value.

7. The system of claim 6, wherein generating the second contone image comprises modifying the first contone image by applying an image enlargement operation upon determining that the print preview request indicates the request resolution value greater than the first resolution value.

8. The system of claim 7, further comprising determining whether the print preview request indicates the request resolution value equal to the first resolution value and identifying the first contone image as the display image upon determining the print preview request indicates the request resolution value equal to the first resolution value.

9. The system of claim 1, wherein generating the ink usage estimation data comprises generating a gray level histogram data based on the first contone image.

10. The system of claim 4, wherein the memory device to further store a graphical user interface (GUI) and the one or more processors to execute the GUI to receive the print preview request.

11. The system of claim 1, further comprising a printer.

12. At least one computer readable medium having instructions stored thereon, which when executed by one or more processors, cause the processors to:
receive an input image file;
process the input image file to generate a first contone image;
generate ink usage estimation data based on the first contone image;
identify the first contone image as the display image; and
initiate print preview display of the display image.

13. The computer readable medium of claim 12, wherein generating the ink usage estimation data comprises generating maintenance ink usage data based on the first contone image and generating modified ink usage data based on the ink usage estimation data and the maintenance ink usage data.

14. The computer readable medium of claim 12, having instructions stored thereon, which when executed by one or more processors, further cause the processors to:
receive a print preview request; and
generate a second contone image based on the first contone image and identify the second contone image as the display image.

15. The computer readable medium of claim 14, wherein the first contone image comprises a first image resolution value and the second contone image comprises a second image resolution value, the first image resolution value different than the second image resolution value.

16. The computer readable medium of claim 15, wherein generating the second contone image comprises determining whether the print preview request indicates a request resolution value greater than the first resolution value and modifying the first contone image by applying an image reduction operation upon determining that the print preview request indicates the request resolution value not greater than the first resolution value.

17. A method comprising:
receiving an input image file;
processing the input image file to generate a first contone image;
generating ink usage estimation data based on the first contone image;
identifying the first contone image as the display image; and
initiating print preview display of the display image.

18. The method of claim 17, further comprising wherein generating the ink usage estimation data comprises generating maintenance ink usage data based on the first contone image and generating modified ink usage data based on the ink usage estimation data and the maintenance ink usage data.

19. The method of claim 17, further comprising:
receiving a print preview request; and
generating a second contone image based on the first contone image and identify the second contone image as the display image.

20. The method of claim 19, wherein the first contone image comprises a first image resolution value and the second contone image comprises a second image resolution value, the first image resolution value different than the second image resolution value.
